(19) United States
(12) Patent Application Publication
(10) Pub. No.: US 2026/0013467 A1
(43) Pub. Date: Jan. 15, 2026

(54) PET WATER DISPENSER

(71) Applicant: Weijun XIAO, Shenzhen City (CN)

(72) Inventor: Weijun XIAO, Shenzhen City (CN)

(73) Assignee: LesoRocity (Shenzhen) Industrial Co., Ltd., Shenzhen (CN)

(21) Appl. No.: 19/337,907

(22) Filed: Sep. 24, 2025

Related U.S. Application Data
(63) Continuation-in-part of application No. 19/023,404, filed on Jan. 16, 2025, now Pat. No. 12,446,545.

(30) Foreign Application Priority Data
Oct. 25, 2024 (CN) 202411498959.2

(51) Int. Cl. A01K 7/02

(52) U.S. Cl. CPC A01K 7/025

(57) ABSTRACT

A siphon-based pet water dispenser includes a water replenishment assembly, a water tank pedestal, and a base assembly. The water replenishment assembly includes a water tank main body with a water outlet port at its bottom portion and a water outlet tank lid. The water tank pedestal supports the water tank main body in a stable inverted position on planar surfaces. The base assembly includes a base main body with a pedestal mounting portion for the water tank pedestal and a water container. Through the siphon principle and structural coordination, the lid is pushed open, enabling continuous water flow into the water container while maintaining a stable water level. After disassembly, the water tank main body stands independently, facilitating transportation and water replenishment. This apparatus provides automatic and stable water supply, effectively solving conventional problems including tipping, inconvenient water replenishment, and water contamination.

### CROSS-REFERENCE TO RELATED APPLICATIONS

This application is a continuation-in-part of U.S. patent application Ser. No. 19/023,404, filed on Jan. 16, 2025, and entitled “Pet Water Dispenser” (now pending), and also claims priority to Chinese Patent Application No. CN2024114989592, filed on Oct. 25, 2024, the entire disclosures of which are incorporated herein by reference.

### TECHNICAL FIELD

The present invention relates the technical field of pet supplies, and in particular, to a pet water dispenser.

### BACKGROUND OF THE INVENTION

With societal advancement, while enjoying material comforts, people continually pursue enrichment in their spiritual lives. An increasing number of households enjoy keeping pets. Although pets provide companionship and joy, their daily water drinking often presents numerous inconveniences. Conventional methods typically use containers such as basins or bowls to hold water. Pets can easily overturn these water-holding containers during drinking, leading to water contamination. Consumption of unclean water can easily cause illnesses in pets, not only affecting their health but also requiring owners to spend additional time and money on treatment.

Currently, there are some prior art intelligent water dispenser products on the market that can provide a continuous water supply through electrical or smart control. However, their complex structure and relatively high cost make them difficult to popularize. Accordingly, many companies have developed purely mechanical pet water dispensers based on the gravity principle to reduce costs and improve reliability. Nevertheless, for these products, the water tank main body itself cannot stand stably on a planar surface in an inverted state, resulting in inconveniences during use and operation.

To address the above-mentioned problems, the present invention provides a pet water dispenser, which can effectively solve issues such as the inability to stand the water tank main body stably in an inverted state and the inconveniences in use existing in current mechanical water dispensers.

### SUMMARY OF THE INVENTION

In order to overcome the deficiencies of the prior art, the present invention provides a pet water dispenser. The pet water dispenser has a simple structure and is capable of standing stably on any planar surface under the premise that the water outlet port faces downward, thereby further improving the user experience.

The technical solution adopted by the present invention to solve the technical problem is as follows.

A pet water dispenser includes a water replenishment assembly, a water tank pedestal, and a base assembly. The water replenishment assembly includes a water tank main body and a water outlet tank lid; the water tank main body is provided with a water outlet port, and the water outlet tank lid is configured to open or close the water outlet port. The water tank pedestal is configured to support the water tank main body such that the water tank main body stands stably on any planar surface on a premise of the water outlet port facing downward. The base assembly includes a base main body, and the base main body is provided with a pedestal mounting portion; the pedestal mounting portion is configured to detachably mount the water tank pedestal to the base assembly, and the base assembly is configured to abut against the water outlet tank lid to allow water to flow into the base assembly for pets to drink.

As an improvement of the present invention, a pet water dispenser includes a water replenishment assembly, a water tank pedestal, and a base assembly. The water replenishment assembly includes a water tank main body and a water outlet tank lid; a bottom portion of the water tank main body is provided with a water outlet port, and the water outlet tank lid is configured to open or close the water outlet port. The water tank pedestal is disposed below the water tank main body and is configured to support the water tank main body, the water tank pedestal is provided with a water tank mounting portion, and the water replenishment assembly is detachably connected to the water tank pedestal through the water tank mounting portion; the water tank pedestal is provided with a plurality of support legs configured to stand on a planar surface such that the water tank main body stands stably on any planar surface on a premise of the water outlet port facing downward. The base assembly includes a base main body and a water container detachably mounted in the base main body, the base main body is provided with a pedestal mounting portion, the pedestal mounting portion is provided with a plurality of pedestal mounting holes, the pedestal mounting holes are configured to detachably receive and secure the support legs of the water tank pedestal to the base assembly, and the water container is configured to abut against the water outlet tank lid to allow water to flow into the water container for pets to drink.

Beneficial effects of the present invention are as follows. By the arrangement of the above structure, the pet water dispenser significantly improves convenience, safety, and hygiene during use. The water tank main body is detachably connected to the water tank pedestal. By means of the support legs of the pedestal, the water tank main body can independently and stably stand on any planar surface even in an inverted state. When the dispenser is fully assembled, the water container automatically pushes open the water outlet tank lid to enable water supply, and upon disassembly, the lid automatically closes to effectively prevent leakage, thereby achieving an intelligent effect of “immediate water supply upon assembly and immediate stoppage upon disassembly”. Meanwhile, all components are easily disassembled for cleaning, ensuring drinking water hygiene. Furthermore, the design of the water container mounted within the base enhances overall stability and avoids the risk of being overturned by pets. The structure is reasonable and reliable. The present invention effectively solves problems existing in conventional products, such as difficulty in handling, cumbersome operation, susceptibility to leakage, and inconvenient cleaning, thereby further improving the user experience.

### BRIEF DESCRIPTION OF DRAWINGS

In order to explain the technical solutions of the embodiments of the present invention more clearly, the following will briefly introduce the accompanying drawings used in the embodiments. The drawings in the following description are only some embodiments of the present invention. Those of ordinary skill in the art can obtain other drawings based on these drawings without creative work. In addition, the accompanying drawings are not drawn to a scale of 1:1, and the relative dimensions of the various elements are only shown as examples in the diagrams, not necessarily drawn to a true scale.

The present invention is further described below in detail in combination with the accompanying drawings and embodiments.

FIG. 1 is a schematic diagram of an overall structure of a pet water dispenser from a first perspective view according to the present invention;

FIG. 2 is a schematic diagram of an overall structure of the pet water dispenser from a second perspective view according to the present invention;

FIG. 3 is a first exploded view of the pet water dispenser according to the present invention;

FIG. 4 is a second exploded view of the pet water dispenser according to the present invention;

FIG. 5 is a third exploded view of the pet water dispenser according to the present invention;

FIG. 6 is a fourth exploded view of the pet water dispenser according to the present invention;

FIG. 7 is a schematic diagram of a cross-sectional structure of the pet water dispenser according to the present invention;

FIG. 8 is an enlarged view of circle A of FIG. 7;

FIG. 9 is an exploded view of the water outlet tank lid of the pet water dispenser from a first angle according to the present invention;

FIG. 10 is an exploded view of the water outlet tank lid of the pet water dispenser from a second angle according to the present invention;

FIG. 11 is an enlarged schematic view of the water tank pedestal of the pet water dispenser from the first angle according to the present invention; and

FIG. 12 is an enlarged schematic view of the water tank pedestal of the pet water dispenser from the second angle according to the present invention.

### DETAILED DESCRIPTION OF THE INVENTION

To make the aforementioned objectives, features, and advantages of the present invention more comprehensible, specific implementations of the present invention are described in detail below in conjunction with the accompanying drawings. In the following description, numerous specific details are set forth to provide a thorough understanding of the present invention. The present invention may, however, be embodied in many forms different from that described here. A person skilled in the art can make similar improvements without departing from the connotation of the present invention. Therefore, the present invention is not limited by the specific embodiments disclosed below.

In the description of the present invention, It is to be understood that the terms “center”, “longitudinal”, “transverse”, “upper”, “lower”, “front”, “rear”, “left”, “right”, “vertical”, “horizontal”, “top”, “bottom”, “inner”, “outer”, “clockwise”, “counterclockwise”, and the like indicate azimuth or positional relationships based on the azimuth or positional relationships shown in the drawings, For purposes of convenience only of describing the present invention and simplifying the description, Rather than indicating or implying that the indicated device or element must have a particular orientation, be constructed and operated in a particular orientation, therefore, not to be construed as limiting the present invention.

In addition, the terms “first” and “second” are used for descriptive purposes only, while not to be construed as indicating or implying relative importance or implicitly specifying the number of technical features indicated thereby, features defining “first,” “second,” and “second” may explicitly or implicitly include one or more of the described features. In the description of the present invention, “multiple” means two or more unless explicitly specified otherwise.

In addition, the terms “install”, “arrange”, “provide”, “connect” and “couple” should be understood broadly. For example, it can be a fixed connection, a detachable connection, an integral structure, a mechanical connection, an electrical connection, a direct connection, an indirect connection through an intermediate medium, or a communication between two devices, elements or components. For ordinary technical personnel in this field, the specific meanings of the above terms in present invention can be understood based on specific circumstances.

In the present invention, unless specific regulation and limitation otherwise, the first feature “onto” or “under” the second feature may include the direct contact of the first feature and the second feature, or may include the contact of the first feature and the second feature through other features between them instead of direct contact. Moreover, the first feature “onto”, “above” and “on” the second feature includes that the first feature is right above and obliquely above the second feature, or merely indicates that the horizontal height of the first feature is higher than the second feature. The first feature “under”, “below” and “down” the second feature includes that the first feature is right above and obliquely above the second feature, or merely indicates that the horizontal height of the first feature is less than the second feature.

It should be noted that when an element is referred to as being “fixed to” another element, the element can be directly on another component or there can be a centered element. When an element is considered to be “connected” to another element, the element can be directly connected to another element or there may be a centered element. The terms “inner”, “outer”, “left”, “right”, and similar expressions used herein are for illustrative purposes only and do not necessarily represent the only implementation.

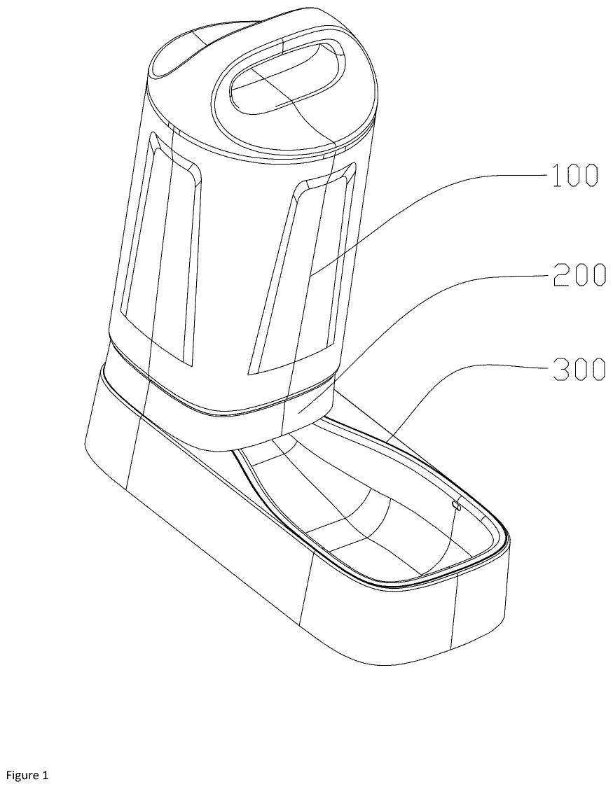

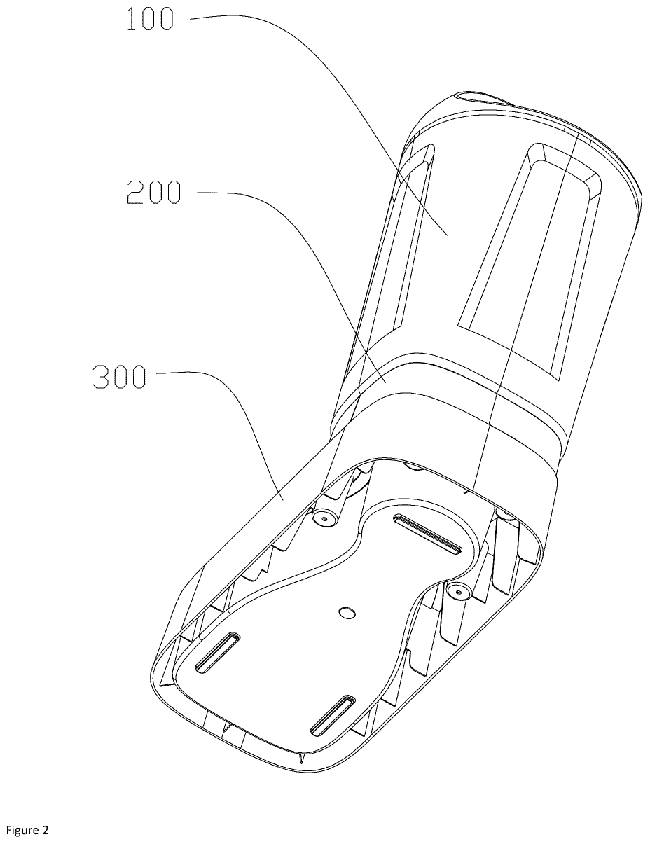

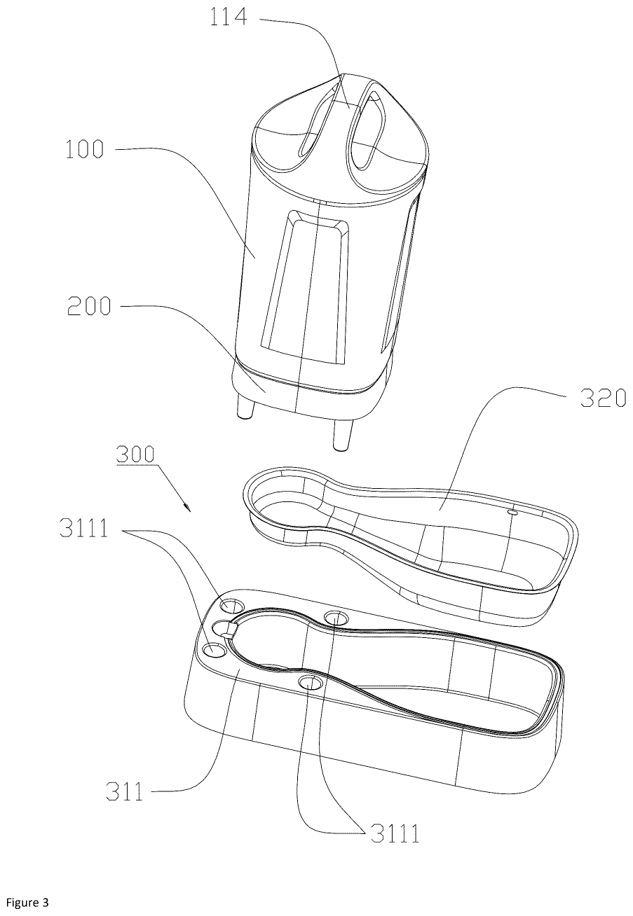

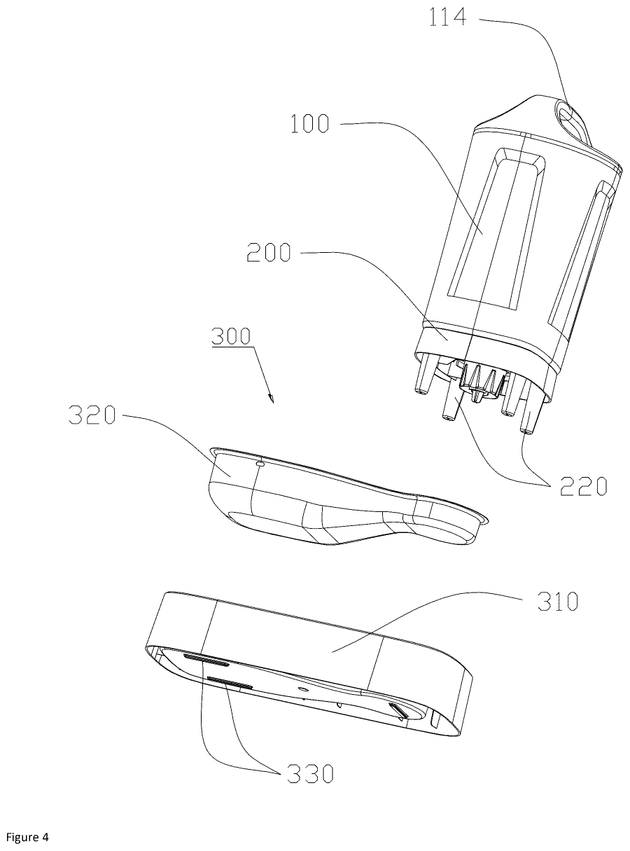

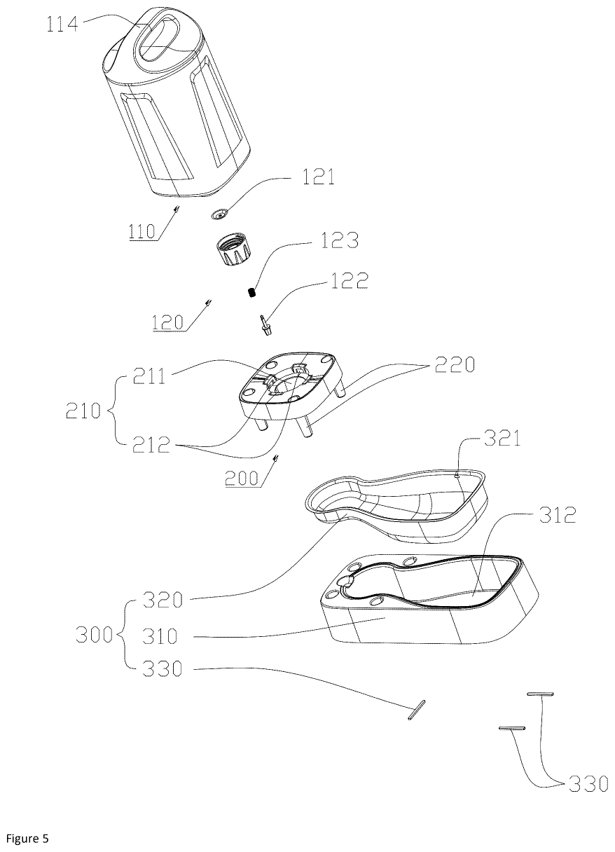

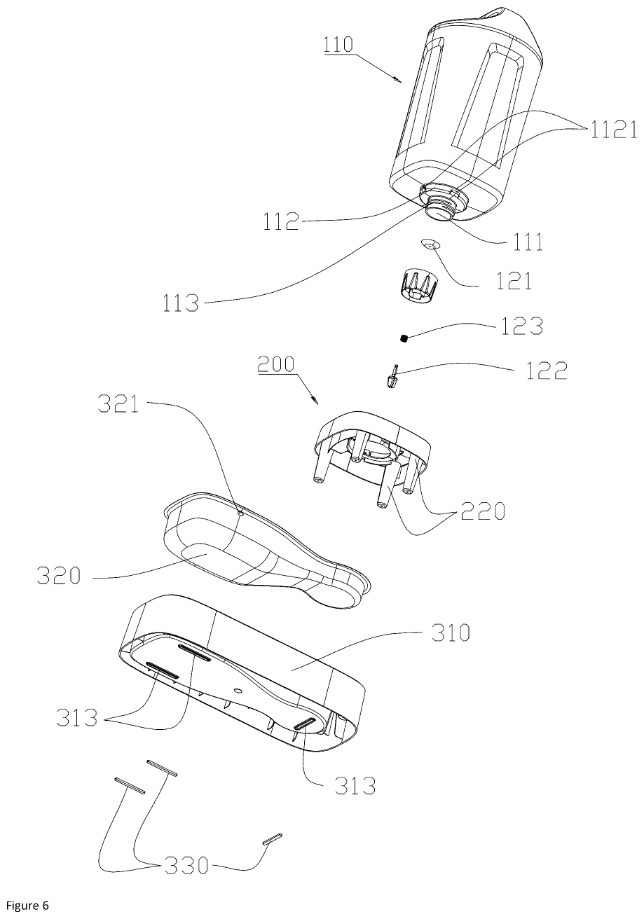

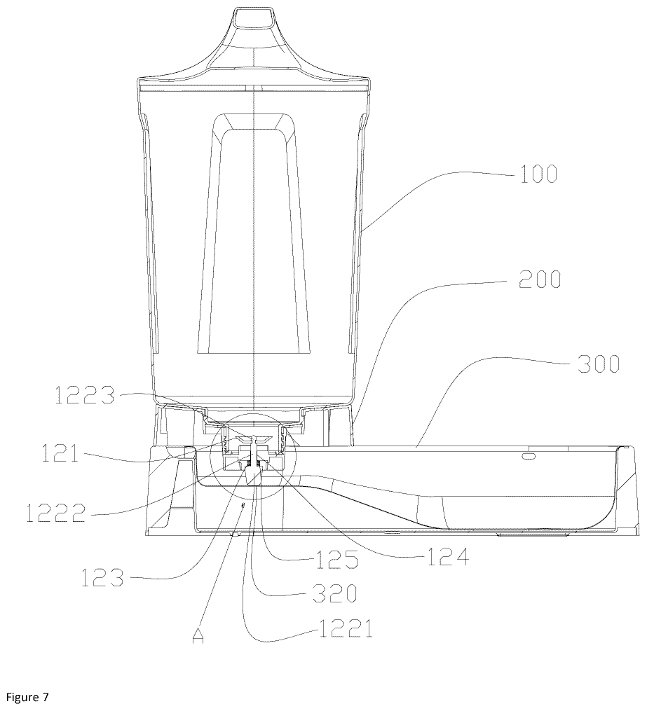

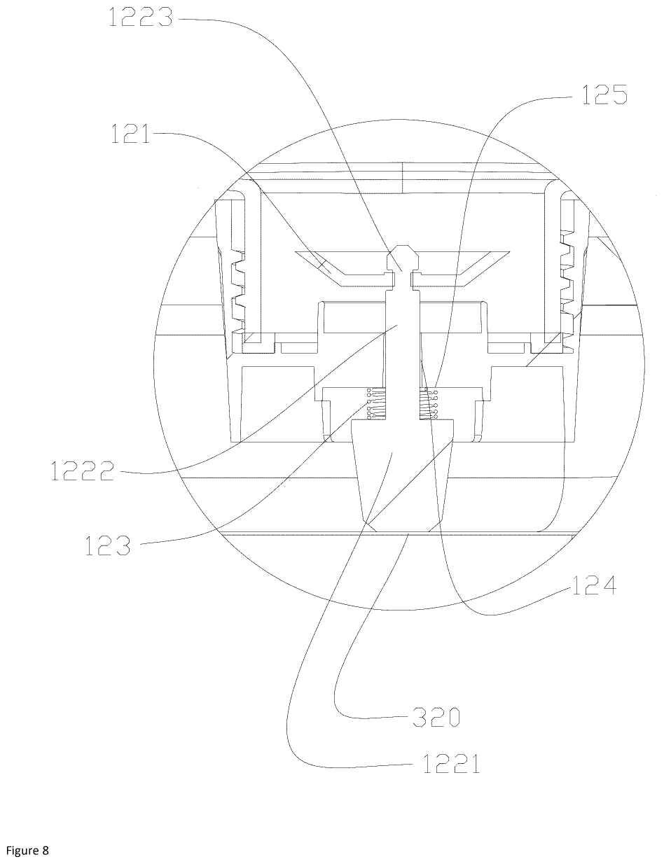

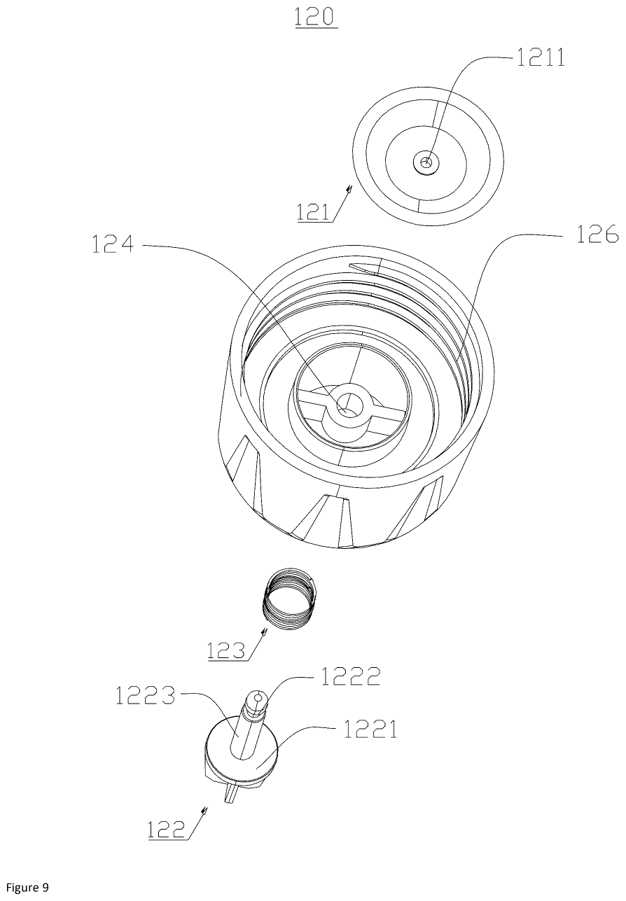

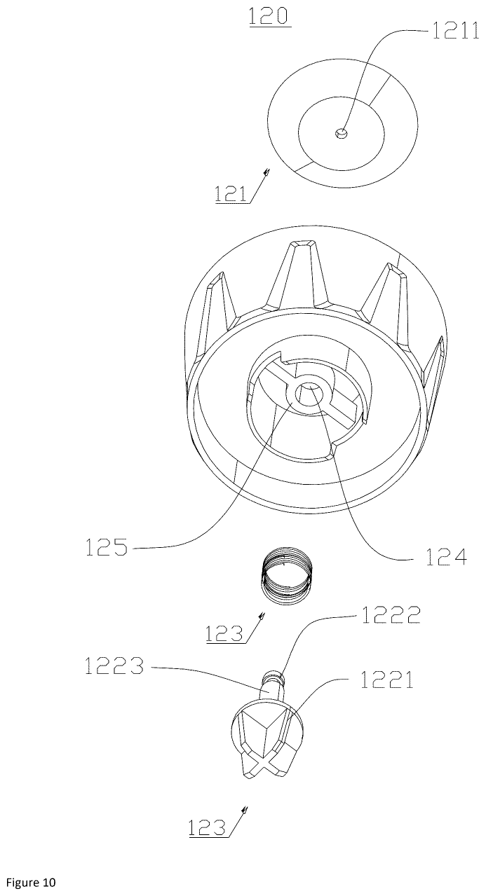

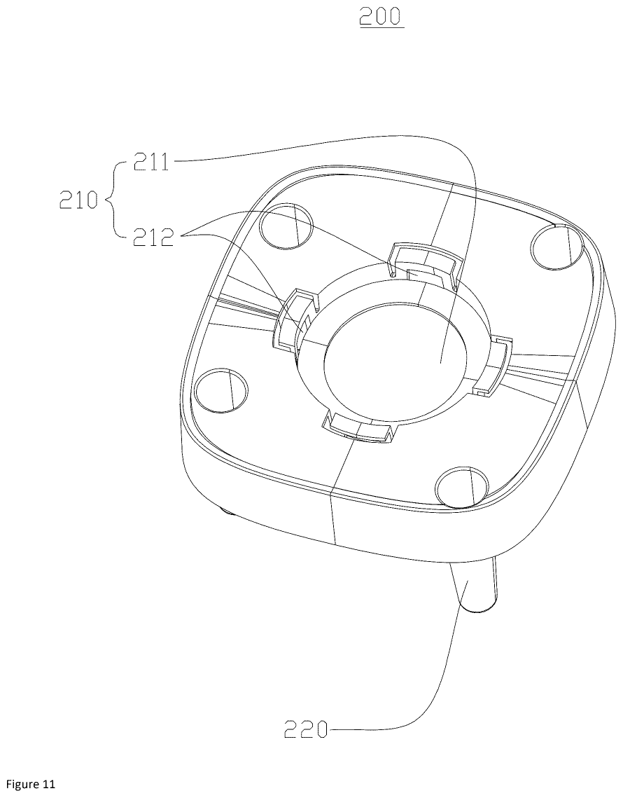

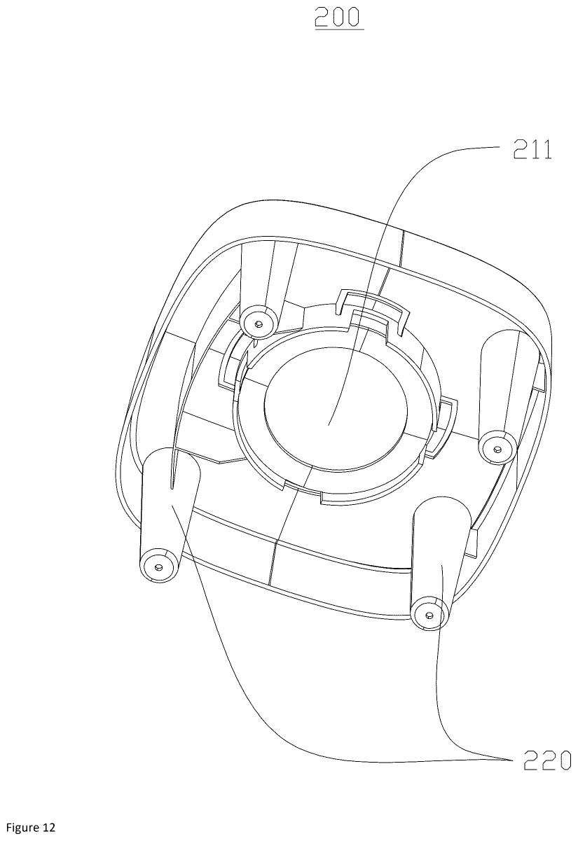

Referring to FIG. 1 to FIG. 12, a pet water dispenser includes:
a water replenishment assembly 100 that includes a water tank main body 110 and a water outlet tank lid 120; the water tank main body 110 is provided with a water outlet port 111, and the water outlet tank lid 120 is configured to open or close the water outlet port 111;
a water tank pedestal 200, wherein the water tank pedestal 200 is configured to support the water tank main body 110 such that the water tank main body 110 stands stably on any planar surface on the premise of the water outlet port 111 facing downward; and
a base assembly 300, wherein the base assembly 300 includes a base main body 310, and the base main body 310 is provided with a pedestal mounting portion 311; the pedestal mounting portion 311 is configured to detachably secure the water tank pedestal 200 to the base assembly 300, and the base assembly 300 is configured to abut against the water outlet tank lid 120 to allow water to flow into the base assembly 300 for consumption by a pet.

By the arrangement of the above structure, during use, the water tank main body 110 serves the function of water storage, the water outlet port 111 provides a passage for water flow output, and the water outlet tank lid 120 controls the water discharge state through opening or closing actions, thereby achieving the basic functions of water storage and water discharge control. The water tank pedestal 200 is dedicated to support and posture stabilization; by supporting the water tank main body 110, it ensures that the water tank main body 110 can stand stably on any planar surface in the critical posture with the water outlet port 111 facing downward, thereby solving the stability issue when the water tank is inverted for water storage. The base assembly 300, on one hand, achieves detachable fixation with the water tank pedestal 200 through the pedestal mounting portion 311 on the base main body 310, allowing flexible assembly and disassembly of the device components to facilitate transportation, storage, and later maintenance; on the other hand, it is configured to abut against the water outlet tank lid 120 to allow water flow to enter its interior, providing a drinking space for pets. Through the functional division and structural adaptation of the various components, the overall solution ensures water storage stability and water discharge controllability, while the detachable design enhances the usability flexibility of the device. It also defines the water flow path for pet drinking, ultimately forming a complete pet water dispenser with a rational structure, convenient use, and adaptation to pet drinking requirements, effectively balancing practicality and ease of use.

In this embodiment, the water tank pedestal 200 is disposed below the water tank main body 110, the water tank pedestal 200 includes a water tank mounting portion 210, and the water tank main body 110 further includes a snap-fit mounting portion 112. The water tank main body 110 and the water tank pedestal 200 are fixedly connected through the water tank mounting portion 210 and the snap-fit mounting portion 112. By the arrangement of the above structure, during use, the water tank pedestal 200 is disposed below the water tank main body 110 and is securely connected thereto through the engagement between the water tank mounting portion 210 and the snap-fit mounting portion 112. This structure not only ensures reliable fixation of the water tank main body 110 in the inverted position, effectively preventing sliding or tipping of the water tank, but also facilitates easy assembly and disassembly of the overall components with simple operation, significantly enhancing stability during use and user convenience.

In this embodiment, the water tank mounting portion 210 includes a mounting through hole 211. When the water tank main body 110 and the water tank pedestal 200 are fixedly connected through the water tank mounting portion 210 and the snap-fit mounting portion 112, the water outlet port 111 passes through the mounting through hole 211. By the arrangement of the above structure, during use, the water tank mounting portion 210 is provided with the mounting through hole 211. When the water tank main body 110 and the water tank pedestal 200 are mutually fixed through the water tank mounting portion 210 and the snap-fit mounting portion 112, the water outlet port 111 accurately passes through the mounting through hole 211. This structure achieves precise positioning of the water outlet port 111, effectively prevents misalignment during assembly, ensures smoothness and sealability of the water flow path, and enhances the connection stability between components and the reliability of the overall structure, thereby making water replenishment simpler and safer.

In this embodiment, the water tank pedestal 200 is provided with a plurality of support legs 220. The plurality of support legs 220 are configured to support the water replenishment assembly 100 such that the water tank main body 110 stands stably on any planar surface on a premise of the water outlet port 111 facing downward. By the arrangement of the above structure, during use, the water tank pedestal 200 is provided with the plurality of support legs 220 that support the overlying water replenishment assembly 100 in a multi-point support manner, significantly enhancing the anti-tipping stability of the water tank main body 110 in the inverted position and enabling it to stand steadily on various planar surfaces. The design of the plurality of support legs 220 ensures that the water outlet port 111 consistently maintains a reliably downward-facing orientation, thereby improving operational safety and placement flexibility.

In this embodiment, the pedestal mounting portion 311 includes a plurality of pedestal mounting holes 3111. The pedestal mounting holes 3111 are configured to detachably receive and secure the support legs 220 to the base assembly 300. By the arrangement of the above structure, during use, the pedestal mounting portion 311 is provided with the plurality of pedestal mounting holes 3111 for detachably receiving and securing the support legs 220 of the water tank pedestal 200, thereby achieving reliable connection between the water tank pedestal 200 and the base assembly 300. This structure not only provides stable support foundation for the overlying water tank main body 110, preventing displacement or tipping during use, but also makes the overall assembly and disassembly operations more convenient and efficient, facilitating cleaning, water replacement or storage by users, and effectively enhancing the product's usability and maintenance efficiency.

In this embodiment, the base assembly 300 further includes a water container 320. The base main body 310 includes an accommodating groove 312, and the accommodating groove 312 is configured to detachably mount the water container 320. When the water container 320 is mounted in the accommodating groove 312 and the pedestal mounting holes 3111 receive and secure the support legs 220 to the base assembly 300, a bottom portion of the water outlet tank lid 120 abuts against the water container 320, and the water outlet tank lid 120 is configured to open the water outlet port 111 to allow water to flow into the water container 320 for pets to drink. By the arrangement of the above structure, during use, the base assembly 300 detachably mounts the water container 320 through the accommodating groove 312. When the water container 320 is properly mounted and the support legs 220 of the water tank pedestal 200 are secured in the pedestal mounting holes 3111, the bottom portion of the water outlet tank lid 120 abuts against and is pushed open by the water container 320, thereby opening the water outlet port 111 and allowing water to flow smoothly into the water container 320 for pets to drink. This integrated structure achieves automatic and continuous water supply from storage to drinking, ensures smooth and hygienic water supply process, and enables quick assembly and disassembly between components, greatly facilitating daily cleaning, maintenance and water replacement, thereby enhancing the practicality and user experience of the product.

In this embodiment, the water outlet tank lid 120 is provided with a water sealing plug 121 and a movable pin 122. The movable pin 122 and the water sealing plug 121 are connected by snap-fit. When the water container 320 is mounted in the accommodating groove 312 and the pedestal mounting holes 3111 receive and secure the support legs 220 to the base assembly 300, the movable pin 122 abuts against the water container 320 and drives the water sealing plug 121 to unblock the water outlet port 111, allowing water to flow into the water container 320. By the arrangement of the above structure, during use, the water outlet tank lid 120 is provided with the water sealing plug 121 and the movable pin 122, which are operatively connected through snap-fit engagement. When the water container 320 is mounted in the accommodating groove 312 and the support legs 220 are secured in the pedestal mounting holes 3111, a bottom portion of the movable pin 122 abuts against and is upwardly actuated by the water container 320, thereby driving the water sealing plug 121 to disengage from the sealed position against the water outlet port 111, achieving unblocking and guiding water flow into the water container 320 for pets to drink. This structure achieves automatic opening and closing control of the water supply process, providing reliable sealing and precise triggering, effectively preventing water leakage or contamination, while enabling automatic reset and flow interruption during disassembly, significantly enhancing the hygiene, safety, and operational convenience of pet drinking.

In this embodiment, the movable pin 122 includes an abutting projection 1221, a connecting projection 1222, and a connecting post 1223. The abutting projection 1221 and the connecting projection 1222 are fixedly connected through the connecting post 1223. The water outlet tank lid 120 is further provided with a spring 123, a pin mounting hole 124, and a tank-lid abutting portion 125. A size of the pin mounting hole 124 matches an external size of the connecting post 1223, and the movable pin 122 is movably mounted to the water outlet tank lid 120 through the connecting post 1223 and the pin mounting hole 124. The spring 123 is sleeved on the connecting post 1223, and two ends of the spring 123 respectively abut against one end of the abutting projection 1221 adjacent to the tank-lid abutting portion 125 and the tank-lid abutting portion 125. When the water container 320 is mounted in the accommodating groove 312 and the pedestal mounting holes 3111 receive and secure the support legs 220 to the base assembly 300, one end of the abutting projection 1221 away from the tank-lid abutting portion 125 abuts against the water container 320 and drives the movable pin 122 to move upward against the spring force of the spring 123, thereby driving the water sealing plug 121 to unblock the water outlet port 111 to allow water to flow into the water container 320 for pets to drink. By the arrangement of the above structure, during use, the movable pin 122 is composed of the abutting projection 1221, the connecting projection 1222, and the connecting post 1223, and is movably engaged with the pin mounting hole 124 on the water outlet tank lid 120 through the connecting post 1223, enabling axial movement. The spring 123 is sleeved on the connecting post 1223, with its two ends respectively abutting against the abutting projection 1221 and the tank-lid abutting portion 125, providing a downward elastic preload in the non-use state to maintain the water sealing plug 121 in a closed position. When the water container 320 is properly mounted and the water tank pedestal 200 is secured to the base assembly 300, a top of the water container 320 abuts against and lifts the abutting projection 1221, driving the movable pin 122 to move upward against the spring force, thereby causing the water sealing plug 121 to disengage from the water outlet port 111 to achieve precise unblocking and automatic water supply. This structure utilizes the synergistic effect of spring reset and mechanical actuation to achieve reliable sealing and automatic opening and closing control of the water supply process, effectively preventing water leakage and external contamination, ensuring drinking water hygiene. Meanwhile, the overall operation is sensitive and the structure is durable, significantly enhancing the operational stability of the product and user experience.

In this embodiment, when the support legs 220 abut against any planar surface to support the water replenishment assembly 100 standing on the planar surface, the end of the abutting projection 1221 remote from the tank-lid abutting portion 125 is disposed above and spaced apart from the planar surface; and the abutting projection 1221, under the action of a spring force and gravity, drives the movable pin 122 to move downward and drives the water sealing plug 121 to close the water outlet port 111. By the arrangement of the above structure, during use, when the water replenishment assembly 100 is independently supported on any planar surface by the support legs 220, the bottom end of the abutting projection 1221 remains above the planar surface and suspended. Under the combined action of the elastic force of the spring 123 and the gravity of the movable pin 122 itself, the movable pin 122 drives the water sealing plug 121 to move downward to reliably close the water outlet port 111. This structure achieves automatic sealing of the water tank in an independent storage state, effectively preventing water leakage or contamination, thereby ensuring the hygiene and safety of stored water and improving the reliability and adaptability of the product in use.

In this embodiment, the water tank main body 110 is provided with a gripping handle 114. This configuration allows a user to conveniently and stably grip the gripping handle 114 during transport of the water tank, significantly improving operational convenience and safety of the water replenishment assembly 100 during water filling, movement, and assembly processes. It effectively prevents accidental detachment caused by wet hands or improper force application, thereby optimizing the overall user experience.

In this embodiment, the water tank mounting portion 210 is provided with a snap-fit hole 212. The snap-fit mounting portion 112 is provided with a snap-fit projection 1121. The water tank mounting portion 210 and the snap-fit mounting portion 112 are connected by snap-fit through the snap-fit hole 212 and the snap-fit projection 1121. By the arrangement of the above structure, during use, the water tank mounting portion 210 is provided with the snap-fit hole 212, and the snap-fit mounting portion 112 of the water tank main body 110 is provided with the snap-fit projection 1121. The connection is established by snap-fit engagement between the hole and the projection. This structure provides definite positioning and a stable connection for the assembly between the water tank main body 110 and the water tank pedestal 200, effectively preventing relative sliding or accidental separation between components, and ensuring the overall structural stability of the product in an inverted use state. Meanwhile, the snap-fit connection is simple to operate and convenient to assemble and disassemble, without requiring additional tools, significantly improving the efficiency and experience of user installation, water replacement, and cleaning maintenance.

In this embodiment, the shape and number of the pedestal mounting holes 3111 correspond to the shape and number of the support legs 220. By the arrangement of the above structure, during use, it is ensured that the water tank pedestal 200 can be accurately and smoothly mounted to the base assembly 300, achieving rapid alignment and reliable fixation between the components, effectively preventing misassembly or shaking, and significantly improving the convenience of assembly and the connection stability of the overall structure.

In this embodiment, the water outlet tank lid 120 is provided with a first threaded portion 126. The water tank main body 110 is provided with a second threaded portion 113, and the second threaded portion 113 is disposed around the water outlet port 111. The water outlet tank lid 120 and the water tank main body 110 are threadedly connected through the first threaded portion 126 and the second threaded portion 113. By the arrangement of the above structure, during use, the threaded connection structure provides reliable and uniform sealing force, ensuring the sealing performance when the water outlet port 111 is closed, and effectively preventing water leakage or intrusion of external contaminants. Meanwhile, the threaded engagement makes the tightening and opening operations of the water outlet tank lid 120 simple and labor-saving, with firm and reliable connection, significantly improving the sealing performance and user convenience of the product.

In this embodiment, the water container 320 is provided with an overflow hole 321. By the arrangement of the above structure, during use, the overflow hole 321 serves as an additional protective measure. In the event of accidental water leakage, it directs excess liquid to be temporarily stored in the base main body 310 (capacity: approximately 600 milliliters), effectively preventing water from overflowing onto the floor, thereby maintaining a dry and clean surrounding environment. This enhances the safety and reliability of the product while reducing the burden of user cleaning and maintenance.

In this embodiment, the base assembly 300 further includes an anti-slip strip 330. The base main body 310 further includes a mounting groove 313. The shape of the mounting groove 313 corresponds to the external shape of the anti-slip strip 330 to mount the anti-slip strip 330. By the arrangement of the above structure, during use, the frictional force between the base assembly 300 and the contact surface is significantly enhanced, effectively preventing the device from sliding or tipping during pet drinking, thereby ensuring the stability and safety of the pet drinking process. Meanwhile, the design of the anti-slip strip 330 also prevents the base assembly 300 from scratching furniture or floor surfaces, providing protection for the usage environment while improving the practicality and reliability of the product.

In this embodiment, the water sealing plug 121 is provided with a connecting through hole 1211. The connecting through hole 1211 is disposed at a central position of the water sealing plug 121. The movable pin 122 and the water sealing plug 121 are connected by snap-fit through the connecting through hole 1211 and the connecting projection 1222. By the arrangement of the above structure, during use, the linkage between the movable pin 122 and the water sealing plug 121 is ensured to be precise and reliable, enabling the water sealing plug 121 to accurately open or close the water outlet port 111 following the upward and downward movement of the movable pin 122. This better achieves precise control of sealing and unblocking, effectively preventing abnormal water leakage or incomplete closure. Meanwhile, the snap-fit connection manner features a simple structure and convenient assembly and disassembly, improving the maintenance convenience of the components.

As described above, one or more embodiments are provided in conjunction with the detailed description, The specific implementation of the present invention is not confirmed to be limited to that the description is similar to or similar to the method, the structure and the like of the present invention, or a plurality of technical deductions or substitutions are made on the premise of the conception of the present invention to be regarded as the protection of the present invention.

1. A pet water dispenser comprising:
a water replenishment assembly, wherein the water replenishment assembly comprises a water tank main body and a water outlet tank lid; the water tank main body is provided with a water outlet port, and the water outlet tank lid is configured to open or close the water outlet port;
a water tank pedestal, wherein the water tank pedestal is configured to support the water tank main body such that the water tank main body stands stably on any planar surface on a premise of the water outlet port facing downward; and
a base assembly, wherein the base assembly comprises a base main body, and the base main body is provided with a pedestal mounting portion; the pedestal mounting portion is configured to detachably mount the water tank pedestal to the base assembly, and the base assembly is configured to abut against the water outlet tank lid to allow water to flow into the base assembly for pets to drink.

2. The pet water dispenser according to claim 1, wherein the water tank pedestal is disposed below the water tank main body; and the water tank pedestal comprises a water tank mounting portion; the water tank main body further comprises a snap-fit mounting portion; and the water tank main body and the water tank pedestal are fixedly connected through the water tank mounting portion and the snap-fit mounting portion.

3. The pet water dispenser according to claim 2, wherein the water tank mounting portion comprises a mounting through hole; and when the water tank main body and the water tank pedestal are fixedly connected through the water tank mounting portion and the snap-fit mounting portion, the water outlet port passes through the mounting through hole.

4. The pet water dispenser according to claim 3, wherein the water tank pedestal is provided with a plurality of support legs; and the plurality of support legs are configured to support the water replenishment assembly such that the water tank main body stands stably on any planar surface on a premise of the water outlet port facing downward.

5. The pet water dispenser according to claim 4, wherein when the water tank main body stands stably on a planar surface on a premise of the water outlet port facing downward, the support legs abut against the planar surface to support the water replenishment assembly, and a lowest point of the water outlet tank lid is higher than the planar surface to avoid direct contact with the planar surface; and at this time, the water outlet tank lid is configured to close the water outlet port.

6. The pet water dispenser according to claim 4, wherein the pedestal mounting portion comprises a plurality of pedestal mounting holes; and the pedestal mounting holes are configured to detachably receive and secure the support legs to the base assembly.

7. The pet water dispenser according to claim 6, wherein the base assembly further comprises a water container; the base main body comprises an accommodating groove, and the accommodating groove is configured to detachably mount the water container; and when the water container is mounted in the accommodating groove and the pedestal mounting holes receive and secure the support legs to the base assembly, a bottom portion of the water outlet tank lid abuts against the water container, and the water outlet tank lid is configured to open the water outlet port to allow water to flow into the water container for pets to drink.

8. The pet water dispenser according to claim 7, wherein the water outlet tank lid is provided with a water sealing plug and a movable pin; the movable pin and the water sealing plug are connected by snap-fit; and when the water container is mounted in the accommodating groove and the pedestal mounting holes receive and secure the support legs to the base assembly, the movable pin abuts against the water container and drives the water sealing plug to unblock the water outlet port to allow water to flow into the water container.

9. The pet water dispenser according to claim 8, wherein the movable pin comprises an abutting projection, a connecting projection, and a connecting post, and the abutting projection and the connecting projection are fixedly connected through the connecting post;
the water outlet tank lid is further provided with a spring, a pin mounting hole, and a tank-lid abutting portion, wherein a size of the pin mounting hole matches an external size of the connecting post, and the movable pin is movably mounted to the water outlet tank lid through the connecting post and the pin mounting hole;
the spring is sleeved on the connecting post, and two ends of the spring respectively abut against one end of the abutting projection adjacent to the tank-lid abutting portion and the tank-lid abutting portion; and
when the water container is mounted in the accommodating groove and the pedestal mounting holes receive and secure the support legs to the base assembly, one end of the abutting projection away from the tank-lid abutting portion abuts against the water container and drives the movable pin to move upward against a spring force of the spring, thereby driving the water sealing plug to unblock the water outlet port to allow water to flow into the water container for pets to drink.

10. The pet water dispenser according to claim 9, wherein when the support legs abut against any planar surface to support the water replenishment assembly standing on the planar surface, one end of the abutting projection away from the tank-lid abutting portion is disposed above and spaced apart from the planar surface; and the abutting projection, under action of a spring force and gravity, drives the movable pin to move downward and drives the water sealing plug to close the water outlet port.

11. The pet water dispenser according to claim 1, wherein the water tank main body is provided with a gripping handle.

12. The pet water dispenser according to claim 1, wherein the water tank mounting portion is provided with a snap-fit hole; the snap-fit mounting portion is provided with a snap-fit projection; and the water tank mounting portion and the snap-fit mounting portion are connected by snap-fit through the snap-fit hole and the snap-fit projection.

13. The pet water dispenser according to claim 6, wherein a shape and number of the pedestal mounting holes correspond to a shape and number of the support legs.

14. The pet water dispenser according to claim 1, wherein the water outlet tank lid is provided with a first threaded portion; the water tank main body is provided with a second threaded portion, and the second threaded portion is disposed around the water outlet port; and the water outlet tank lid and the water tank main body are threadedly connected through the first threaded portion and the second threaded portion.

15. The pet water dispenser according to claim 7, wherein the water container is provided with an overflow hole.

16. The pet water dispenser according to claim 1, wherein the base assembly further comprises an anti-slip strip; the base main body further comprises a mounting groove; and a shape of the mounting groove corresponds to an external shape of the anti-slip strip to mount the anti-slip strip.

17. The pet water dispenser according to claim 9, wherein the water sealing plug is provided with a connecting through hole; the connecting through hole is disposed at a central position of the water sealing plug; and the movable pin and the water sealing plug are connected by snap-fit through the connecting through hole and the connecting projection.

18. A pet water dispenser, comprising:
a water replenishment assembly, wherein the water replenishment assembly comprises a water tank main body and a water outlet tank lid; a bottom portion of the water tank main body is provided with a water outlet port, and the water outlet tank lid is configured to open or close the water outlet port;
a water tank pedestal, wherein the water tank pedestal is disposed below the water tank main body and is configured to support the water tank main body, the water tank pedestal is provided with a water tank mounting portion, and the water replenishment assembly is detachably connected to the water tank pedestal through the water tank mounting portion; the water tank pedestal is provided with a plurality of support legs configured to stand on a planar surface such that the water tank main body stands stably on any planar surface on a premise of the water outlet port facing downward; and
a base assembly, wherein the base assembly comprises a base main body and a water container detachably mounted in the base main body, the base main body is provided with a pedestal mounting portion, the pedestal mounting portion is provided with a plurality of pedestal mounting holes, the pedestal mounting holes are configured to detachably receive and secure the support legs of the water tank pedestal to the base assembly, and the water container is configured to abut against the water outlet tank lid to allow water to flow into the water container for pets to drink.

19. The pet water dispenser according to claim 18, wherein the water tank mounting portion is provided with a mounting through hole; and when the water replenishment assembly is connected to the water tank pedestal, a bottom portion of the water outlet tank lid passes through the mounting through hole and abuts against the water outlet tank lid to allow water to flow into the water container.

20. The pet water dispenser according to claim 18, wherein the water tank pedestal comprises a snap-fit hole; the water tank main body comprises a snap-fit projection; and the water tank main body and the water tank pedestal are fixedly connected by snap-fit through the snap-fit hole and the snap-fit projection.
